(19) United States
(12) Patent Application Publication
(10) Pub. No.: US 2013/0037656 A1
(43) Pub. Date: Feb. 14, 2013

(54) UTILIZATION OF AN ENHANCED ARTIFICIAL MAGNETOSPHERE FOR SHIELDING AGAINST SPACE ENVIRONMENTAL HAZARDS

(71) Applicant: Albert Francis Messano, JR., Montvale, NJ (US)

(72) Inventor: Albert Francis Messano, JR., Montvale, NJ (US)

(21) Appl. No.: 13/569,340

(22) Filed: Aug. 8, 2012

Related U.S. Application Data
(60) Provisional application No. 61/573,028, filed on Aug. 10, 2011.

(51) Int. Cl. B64G 1/54; G21F 3/00

(52) U.S. Cl. 244/171.7; 250/515.1

(57) ABSTRACT

This invention relates to technology used for creating an enhanced artificial magnetosphere or electromagnetic shield for use in both manned and unmanned spacecraft. The invention includes an Interference Generating Pattern (IGP) which is tuned to the high-frequency radiation of X-rays and gamma rays and a conformal magnetic field. This technology will reduce the exposure of astronauts or other space travelers, as well as radiation-sensitive equipment, to the environmental hazards present therein. The net result will be reduced radiation intensity in order to create a space radiation-free environment as to render space travel safe.

This application claims the benefit of application No. 61/573,028 filed Aug. 10, 2011, the entire content of which is expressly incorporated herein by reference thereto.

### TECHNICAL FIELD

This invention relates to technology used for creating an enhanced artificial magnetosphere and an electromagnetic shield for use in both manned and unmanned spacecraft. This technology will reduce the exposure of astronauts or other space travelers, as well as radiation-sensitive equipment, to the environmental hazards present therein. The net result will be reduced radiation intensity in order to create a space radiation-free environment as to render space travel safe.

### BACKGROUND OF THE INVENTION

Space travel has been a reality of modern life since the early 1950's. Much progress has been made in both manned and unmanned missions. The sophistication of autonomous, long-range planetary probes now in use is a far cry from the Soviet-era Sputnik variety of artificial satellite. Similarly, the recently retired Space Shuttle and the currently on-orbit International Space Station (ISS) is nothing like the class of Yuri Gagarin “spam-in-a-can” capsules.

Yet both manned and unmanned spacecraft, modern or not, are exposed to the same environmental hazards present in interplanetary space. These hazards and others will be a concern of future, more ambitious missions. The National Aeronautics and Space Administration (NASA) categorize the space environment as having four (4) components: Vacuum, Neutral, Plasma and Radiation. This invention will focus on the last two components, namely Plasma and Radiation. The Radiation category is further broken down into three subcomponents. These are (Trapped) Radiation, Galactic Cosmic Rays (GCR) and Solar Particle Events (SPE).

Currently, the NASA Space Radiation Analysis Group's (SRAG) strategy is to protect current, and future, generations of astronauts involves passive techniques. These include evaluating and projecting anticipated doses of exposure, modeling such exposure, measuring such dosage via instrumentation and ongoing mission support. NASA SRAG furthermore states that the number one parameter which affects astronaut exposure is “spacecraft structure.” Yet a variety of materials utilized in spacecraft construction are viewed as having “limited effectiveness” against SPE and GCR. Clearly a new and more proactive shielding approach must be developed.

### SUMMARY OF THE INVENTION

This invention relates to technology used for creating an enhanced artificial magnetosphere or electromagnetic shield for use in both manned and unmanned spacecraft. This technology will reduce the exposure of astronauts or other space travelers, as well as radiation-sensitive equipment, to the environmental hazards present therein. The net result will be reduced radiation intensity in order to create a space radiation-free environment as to render space travel safe.

There are two components to this invention. The first is the use of an Interference Generating Pattern (IGP) which is tuned to the high-frequency radiation of X-rays and gamma rays. The frequencies of X-rays generally range from 10¹⁷ to 10²⁰ Hertz (Hz). This puts the wavelength of this radiation between 10⁻⁹ to 10⁻¹¹ meters, smaller than an Angstrom. The frequencies of gamma rays are even higher, generally 10²⁰ Hz and above. This puts the wavelength of this radiation correspondingly smaller. The IGP will create a shield against the electromagnetic radiation danger identified by NASA and prevalent in the space environment.

The second component of this invention is a conformal magnetic field. The field generated is the Magnetic Field Density (symbol B) vector. This vector field is created by the rotary movement of electrical current conductors embedded in the outer layer of the spacecraft that is to be protected. This resultant field tends to be spherical in shape but will become altered in shape, depending on the ambient magnetic field.

As such, this artificially produced magnetic shield, referred to as the Artificial MagnetoSphere or AMS, behaves identically to the Earth's naturally-produced magnetosphere, but this resultant AMS field will take the shape of the spacecraft it is protecting. The artificial magnetosphere of the invention acts the same way as the Earth's magnetosphere does. Namely, it creates a path which enables charged particles to slip around the spacecraft, in a manner similar to the way the Earth shields against charged particles from the Sun's “solar wind”. The aforementioned “solar wind” is comprised primarily of charged particles of electrons (negative charge) and protons, which are hydrogen nuclei (positive charge). Different concentrations of these particles yield different compositions of the solar wind. It is this solar wind that comprises the SPE hazard for which NASA has a valid concern.

The GCR hazard originates from outside and beyond our solar system. The GCR is comprised of ionized atoms, similar to the protons of the solar wind, and even heavier ions as well. All of these ions are travelling are high velocities close to light speed. This is referred to as “relativistic” velocity. However, these particles are ionized nonetheless and will be deflected around the spacecraft, just as the Earth's magnetosphere shields us from “cosmic rays” also known as GCR.

In terms of the IGP, this component is generally one that is generally but not-necessarily non-conductive and is or includes a diffraction grating. The IGP is positioned adjacent the environment between the environment and high frequency radiation signals. Preferably, the IGP is provided as a support member configured in the shape of a diffraction grating, and includes a paint or coating of a non-conductive material having a high dielectric constant thereon. The dielectric materials include families of materials of high dielectric constant, K, and including compounds of silicon and of carbon, refractory materials, rare earth materials, or semiconductor materials. The paint or coating is applied at a generally uniform thickness upon the diffraction grating configured support member.

The IGP described herein is advantageously configured to attenuate high frequency radiation in the range of 10¹³ to 10²⁰ MHZ and higher to protect against the electromagnetic radiation component. This component consists of gamma ray and X-ray radiation. Advantageously, interference generating pattern reduces the high frequency signal by at least 20 dB to 50 dB. As such, the IGP structures will be of the order of nanometers or smaller. Generating structures this small is well within the current capability of solid state chip fabricators in Silicon Valley.

It is the combination of IGP and artificial magnetic field (AMS) that enhances the artificial magnetosphere.

### BRIEF DESCRIPTION OF THE DRAWINGS

Preferred embodiments of the invention are disclosed in the following drawing figures, wherein:

FIG. 1 is a schematic diagram of the Electromagnetic Spectrum;

FIG. 2 is a schematic representation of the Earth's Magnetosphere;

FIG. 3 is a depiction of a Typical IGP;

FIG. 4 is a depiction of a Solenoidal Magnetic Field;

FIG. 5 is a depiction of an Artificial MagnetoSphere (AMS);

FIG. 6 is a depiction of an AMS Magnetic Field; and

FIG. 7 is a depiction of an IGP/AMS Layercake.

### DETAILED DESCRIPTION OF THE PREFERRED EMBODIMENTS

This invention relates to technology used for creating an enhanced artificial magnetosphere and an electromagnetic shield for use in both manned and unmanned spacecraft. This technology will reduce the exposure of astronauts or other space travelers, as well as radiation-sensitive equipment, to the environmental hazards present therein. The net result will be reduced radiation intensity in order to create a space radiation-free environment as to render space travel safe.

Thus, the invention relates to a method of providing a spacecraft with an enhanced artificial magnetosphere or electromagnetic shield, which comprises providing the spacecraft with an Interference Generating Pattern (IGP) which is tuned to high-frequency radiation of X-rays and gamma rays, and embedding electrical current conductors in or near an outer surface of the spacecraft, thus creating a vector field due to rotational movement of the spaceship to shield against electromagnetic radiation dangers prevalent in outer space.

In this method, the IGP is configured to attenuate high frequency radiation in the range of 10¹³ to 10²⁰ MHZ and to reduce high frequency signals by at least 20 dB to 50 dB. Preferably, the IGP includes a diffraction grating provided as a paint or coating on one or more of the interior wall(s), ceiling or floor of the spacecraft.

The invention also relates to an electromagnetic radiation-free spacecraft that includes a non-conductive interference generating pattern (IGP) which includes a diffraction grating that is tuned to high-frequency radiation of X-rays and gamma rays, and electrical current conductors in or near an outer surface of the spacecraft, thus creating a vector field due to rotational movement of the spaceship to shield against electromagnetic radiation dangers prevalent in outer space.

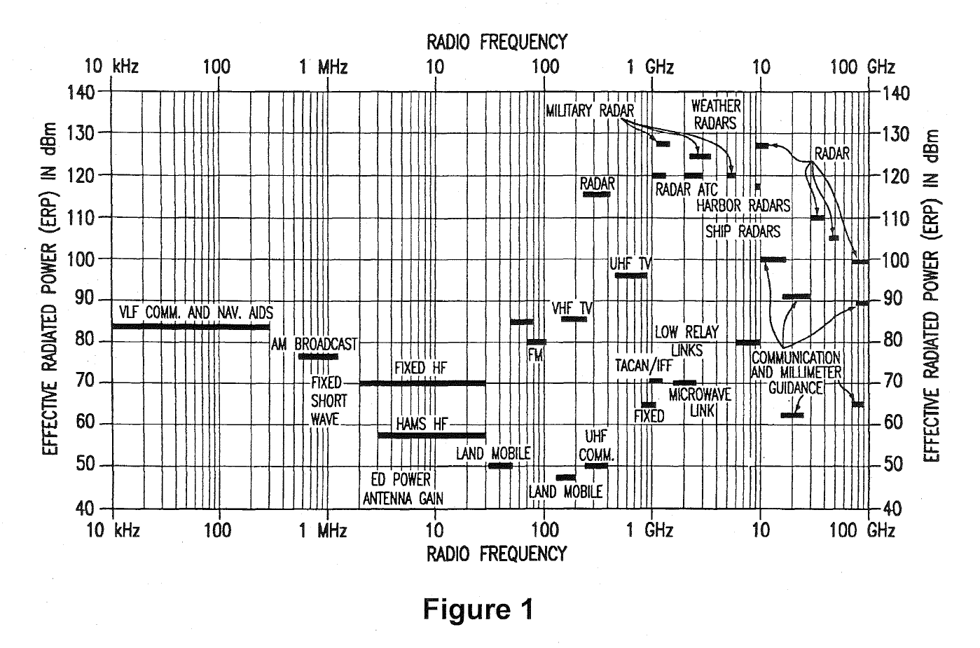

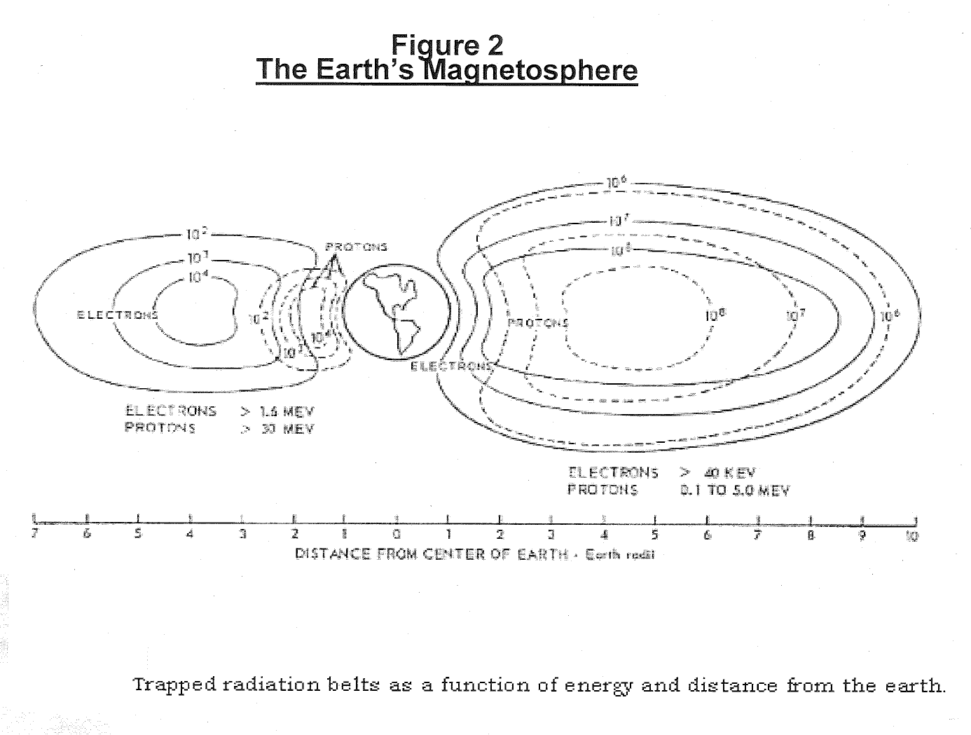

There are two components to this invention. The first component which is the IGP, is disclosed in U.S. Pat. Nos. 6,785,512 and 7,366,472, the entire content of each which is expressly incorporated herein by reference thereto. As noted, the IGP is tuned to the high-frequency radiation of X-rays and gamma rays. The frequencies of X-rays generally range from 10¹⁷ to 10²⁰ Hertz (Hz). This puts the wavelength of this radiation between 10⁻⁹ to 10⁻¹¹ meters, smaller than an Angstrom. The frequencies of gamma rays are even higher, generally 10²⁰ Hz and above. This puts the wavelength of this radiation correspondingly smaller. The ElectroMagnetic (EM) spectrum is shown in FIG. 1. The IGP will create a shield against the electromagnetic radiation prevalent in the space environment. FIG. 2 depicts the Earth's magnetic environment in space.

As previously disclosed, the previous patents are totally passive. It does not transmit any EM signal at all. This means it does not have any RF-related health effects whatsoever.

This invention utilizes materials that are:
Generally nonconductive
Environmentally safe
Non-carcinogenic
Chemically inert, non-toxic, non-combustible and non-corrosive
Naturally occurring or man-made
Organically or inorganically based
Not part of an existing grounding or bonding system
Readily available, economically inexpensive, and easy to apply

As a result, the previous patents will have a beneficial impact on public safety and health while eliminating creating a shield against selected frequencies (wavelengths) of electromagnetic radiation. The IGP described herein is advantageously configured to attenuate radio frequency radiation in the range of 10¹⁶ to 10²² 2 HZ and higher to protect against the electromagnetic radiation component. These frequencies consist of gamma ray and X-ray radiation. The wavelengths of this electromagnetic radiation ranges from 10⁻⁹ to 10⁻¹³ meters. As such, the IGP structures will be of the order of nanometers or smaller. Generating structures this small is well within the current capability of solid state chip fabricators in Silicon Valley. Advantageously, interference generating pattern reduces the high frequency signal by at least 20 dB to 50 dB.

Note that a basic principal of physics reveals the relationship between the frequency and the wavelength of an EM wave:

C=Wavelength×Frequency
where C=the speed of light
   This calculation yields an inverse relationship between frequency and wavelength. Consequently, high frequency radiation with frequencies in the range of 10¹⁶ to 10²² 2 Hz and have wavelengths in the range of 10⁻⁹ to 10⁻¹³ meters. These frequencies and wavelengths of gamma ray and X-ray radiation which offer the greatest space hazard to both humans and machines

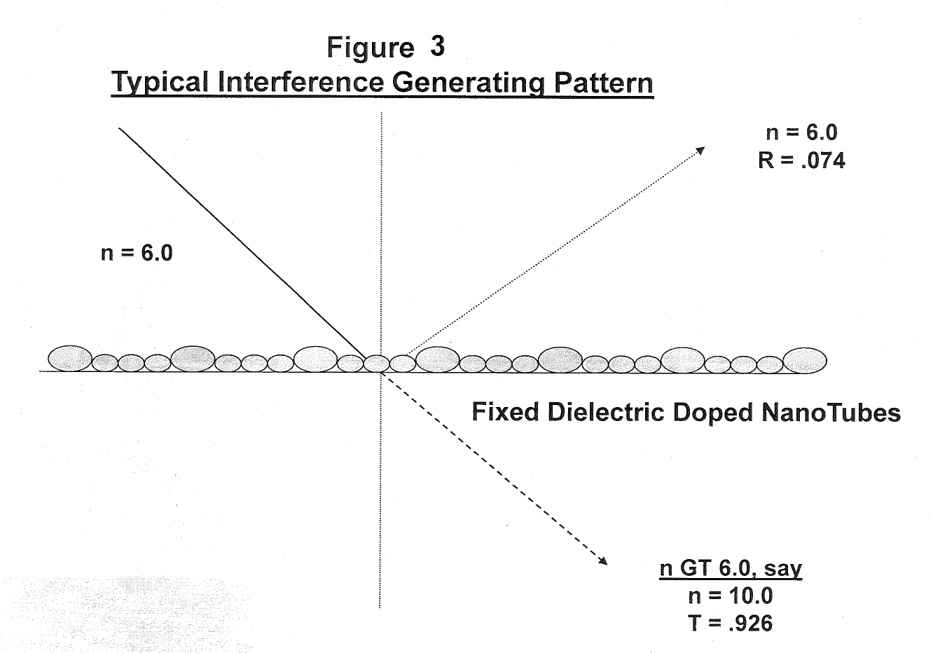

In order to reduce EM radiation and create an EM radiation-free environment, the previous patents utilize the principles of wave effects on the surface of a solid. A typical IGP will take the form of FIG. 3.

These wave effects when an incident wave is directed at an angle against the surface of a solid. Part of the wave, called a transmitted wave, passes into the solid while another part of the wave is reflected from the surface of the solid at an angle. The transmitted wave is also called a refracted wave. By reflecting a greater portion of an EM wave, a much smaller portion is transmitted or refracted. With a sufficient reduction of the wave strength, as explained below, the incident wave becomes weaker.

The IGP preferably uses the application of materials in the family of dielectrics and other families of materials as well to reduce, or attenuate, RF signal strength by absorption, reflection, and refraction and interference generation. For example, refractory materials, rare earth materials, or semiconductor materials may be used. All that is required is that the materials have high dielectric constants and be cost-effective for the specific use. Preferably, the dielectric constant is in the range of 6 to 100 although there is no upper limit such that materials of dielectric constants greater than 100 could be of specific use with this invention.

Calculations indicate that, depending on the thickness of the material used, these materials could generate significant reduction in signal strength, called attenuation, as well as significant reflection and reflection effects (called phase changes) for the portions of the RF spectrum under consideration. These material effects, coupled with proper IGP design, could provide a signal strength reduction of 10 to 50 decibels (dB), with higher reductions being more effective. A 50 dB reduction would lower the signal strength to a level of one hundred thousandth of its original value, thus effectively eliminating the signal. A reduction of at least 20 dB is desired in order to create a substantially radiation-free environment.

In free space, the size of the grain and the structures constructed with such grains determines what portion of the EM spectrum is affected. Since wavelength is inversely proportional to frequency, lower parts of the EM frequency spectrum would be affected by a larger grain size, on the order of nanometers. At any scale, these materials would be utilized to create physical structures or patterns which will more closely approximate the wavelength of RF spectrum under consideration.

Specifically, the materials are applied in a manner as to create the diffraction grating pattern or IGP, which is comparable with the wavelengths of the RF spectrum under consideration. The grating angle, also called blaze angle, can be 45 degrees so that the grating spacing will be equal to the wavelength of the high frequency in question. The grating was to be constructed with either a triangular or a sawtooth diffraction pattern, which offer more reflective surfaces to the incident wave.

Prior to dielectric IGPs, the prior art provided electrical shielding based on the principles of a Faraday cage. This cage intercepts radio frequency waves in a manner similar to that of an antenna and guides the signal away over a conductive network made of conductive metal wire or foil. The cage must be made of metal or otherwise be conductive so that the incoming waves can be dissipated and grounded. The scientific principle behind the Faraday cage is that the electric charge on a conductor resides only on its exterior and had no influence on anything enclosed within it.

In contrast, the IGP operates by interfering with the electromagnetic properties of incoming radio signal. First of all, an incoming radio signal impinges on a coating of dielectric material in an IGP pattern that is or includes a diffraction grating. The pattern can be provided by preparing a series of lines or shapes of the sawteeth, preferably as a shape or block of non-conductive, inorganic material. It also can be provided by making the pattern of another non-conductive material, and then applying the inorganic material upon the pattern as a coating. In either case, the diffraction grating of the IGP acts as a mirror to reflect a certain portion of the radio signal and decreases its strength. The remaining radio signal then impinges upon the IGP, which creates interference that reduces the strength of the wave. This IGP is used to essentially create a box through which high frequency signals can pass only at very much reduced strength if at all.

The IGP has absolutely no reliance on the electrical properties of the incoming radio waves, only upon the electromagnetic, or wave, properties of the incoming radio signal. Thus, dielectric materials, which are good insulators but very poor conductors, are utilized to form a non-conductive IGP that blocks the strength or transmission of the high frequency radiation signals by attenuation of signal wavelength. This construction provides two different and unexpected advantages over Faraday cages: first, the entire system is non-conductive, and second, it does not rely upon electrical characteristics to prevent or reduce signal transmission. The latter point is of great importance since it avoids all the problems of an electrically conductive Faraday cage. In addition, the costs for the materials and their installation are significantly lower than for preparing conductive cages. Thus, the previous invention provides more simplicity and reasonable costs so that the system can be more readily implemented.

The performance of the IPG is based upon the operation of a diffraction grating. The diffraction grating can be applied in a periodic pattern. The periodicity of the pattern will be determined by the frequency and, therefore the wavelength of the high frequencies under consideration. The period may be based on either the full wavelength or the quarter-wavelength of the frequency under consideration to create the IGP. The net result is to create a series of “double slits” to act as additional interference generators.

The grating is applied in a periodic pattern. The periodicity of the pattern was to be determined by the frequency and, therefore the wavelength of the RF frequencies under consideration. The period may be based on either the full wavelength or the quarter-wavelength of the frequency under consideration to create an interference pattern. The net result is to create a series of “double slits” to act as additional interference generators.

By attenuating the wavelength and creating a given fractional wavelength design, various designs can be achieved. In addition, the IGP can be provided in multiple layers for applications where greater shielding security or more critical shielding is needed. For certain materials, the IGP can be provided within the thickness of the material, either in layers or in different positions throughout the depth of material to provide greater interference with the signals.

The IGP will maximize the interference generated for these selected frequencies. If desired, this technique may be optimized for whatever frequency or range of frequencies is under consideration. Depending on the frequencies selected and the application, the IGP may be built either horizontally or vertically into then building material or upon the structure. In the far field of the EM wave, the IGP will typically appear as a surface roughness feature on whatever substrate is used. The IGP's may be stacked to provide additional and more secure shielding. Two different IGPs facing in opposite directions can be placed one on top of the other with patters intermeshing so that a relatively flat construction is obtained. The same result can be achieved with different IGPs except that the intermeshing of the patters will not be so complementary.

Additional patterns can be used: gratings of cones, spheres and other geometric shapes. These patterns would be sized appropriately for the wavelength under consideration. These patterns can be incorporated into structures that were composed of either vertical or horizontal layers. A plurality of cones can be arranged adjacent each other or can be placed alongside to provide the desired shielding. Furthermore the layers within the structure could be offset along their major axis creating a “polarizing” effect. The overall structure, pattern and material of the IGP would depend on the frequency, cost and operating constraints imposed by the overall design. Another way of constructing the IGP is to prepare a thin layer of nanoparticles in a predetermined arrangement so that it can act as an IGP. For examples, nanoparticles can be grown in a face-centered cubic crystal structure with the crystal structure oriented to provide the desired shielding. Alternatively, nanoparticles can be grown in a body-centered cubic structure.

The present method can include superimposing a plurality of support members to provide IGPs that attenuate the entire range of high frequency radiation. Alternatively, the support member can be comprised of different IGPs so as to substantially attenuate the entire range of high frequency radiation. The support member can be provided in the form of a grating, cone, sphere or polygon. Also, the IGP may be comprised of different patterns constructed with different physical dimensions for each pattern. For example, the IGP may be comprised of vertical layering of the different multiple patterns, or of horizontal layering of the different multiple patterns. Also, the IGP may be comprised of vertical or horizontal layering of the different multiple patterns which are axially offset from each other.

In order to create substantially RF-free environments which may be optimized for specific frequencies. A number of different techniques can be used to apply these materials to the enclosure to create either a fixed, portable or mobile RF-free environment.

The second component of this invention is a conformal magnetic field. The field generated is the Magnetic Field Density (symbol B) vector. This vector field is created by the rotary movement of electrical current conductors embedded in the outer layer of the space (spacecraft) to be thus protected. This resultant field tends to be spherical in shape but will become altered in shape, depending on the ambient magnetic field.

The ambient magnetic field density of the Interplanetary Magnetic Field (IMF), through which a spacecraft passes, is usually in the range of 1 to 10 nano Teslas, abbreviated 1 to 10 nT. A nano Tesla or nT is 1×10⁹ Teslas. Additionally, 1 nT equals 1×10⁵ Gauss, another magnetic density unit. During many energetic solar events, as occurred during the Summer of 2012, the IMF may approach levels as high as 15 nT.

The Earth's creates its own magnetic shield called the Magnetosphere. The strength of the MagnetoSphere averages in the vicinity of 5 nT, which is generally sufficient to create the necessary shielding. However, in the Earth's case, the magnetosphere is created by the spinning solid and liquid metallic inner and outer cores of the earth. This is the natural method by which certain planetary objects, such as the Earth, create their life-supporting magnetic fields.

As such, this artificially produced magnetic shield, referred to as the Artificial MagnetoSphere or AMS, behaves identically to the Earth's naturally-produced magnetosphere. However, this resultant AMS field will take the shape of the spacecraft it is protecting. The artificial magnetosphere of the invention acts the same way as the Earth's magnetosphere does. Namely, it creates a path which enables charged particles to slip around the spacecraft, in a manner similar to the way the Earth shields against charged particles from the Sun's “solar wind”. The aforementioned “solar wind” is comprised primarily of charged particles of electrons (negative charge) and protons, which are hydrogen nuclei (positive charge). Different concentrations of these particles yield different compositions of the solar wind. It is this solar wind that comprises the SPE hazard for which NASA has a valid concern.

The GCR hazard originates from outside and beyond our solar system. The GCR is comprised of ionized atoms, similar to the protons of the solar wind, and even heavier ions as well. All of these ions are travelling are high velocities close to light speed. This is referred to as “relativistic” velocity. However, these particles are ionized nonetheless and will be deflected around the spacecraft, just as the Earth's magnetosphere shields us from “cosmic rays” also known as GCR.

The purpose of the AMS is to provide the spacecraft with protection from SPE, GCR and other charged particle hazards yet to be determined. As stated above, the expected maximum magnetic field strength is on the order of 20 nT. The method of creating this is similar to the method by which the Earth creates its own MagnetoSphere as above.

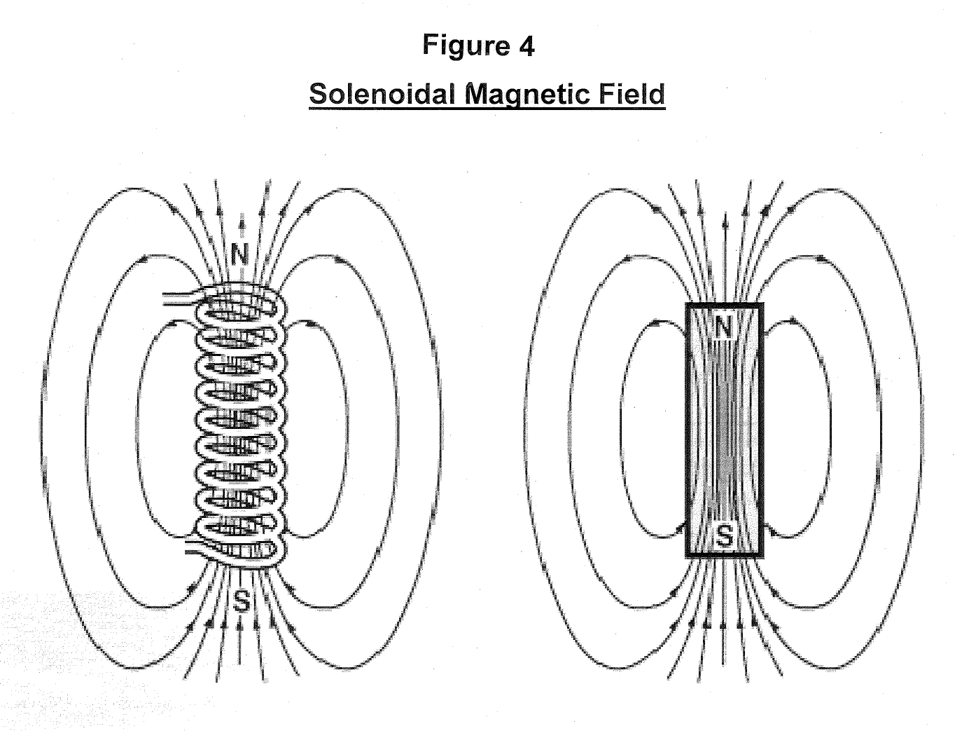

One model of the Earth's MagnetoSphere depicts a bar magnet running North to South through the Earth's core. Opposite poles attract. So in order for a conventional compass needle to point “North”, the Earth's South Pole of its bar magnet would be located at the Earth's geographical North pole and vice versa. Another model would place the magnetic poles opposite of this. Regardless of their location, the North-South pole pair would create a solenoidal magnetic field as depicted in FIG. 4.

While the Earth's magnetic field is the results of the dynamics of the Earth's molten iron and nickel core, the same solenoidal may be produced by a specific electrical wiring configuration called a “solenoid”. The magnetic field produced by such an electromagnetic solenoid is depicted in FIG. 4 as well.

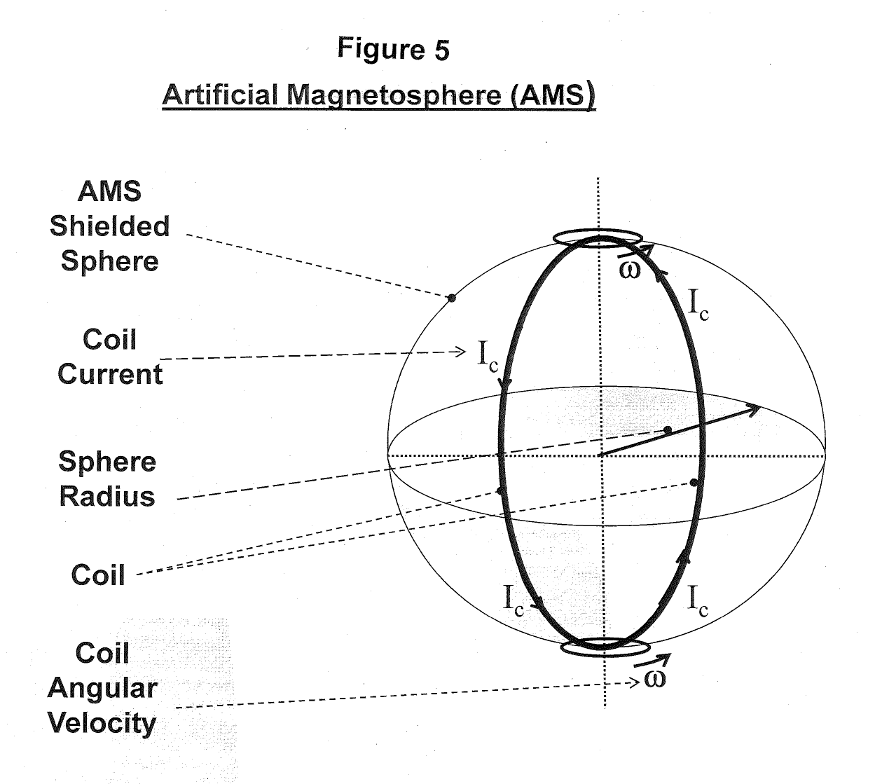

The current invention proposes to utilize this electromagnetic solenoid approach in order to create the AMS. The configuration of the AMS generation scheme is depicted in FIG. 5. For the purposes of description, it assumed that the spacecraft in the shape of a sphere. The actual shape of the spacecraft is not critical other than to insure that it is symmetrical about at least one axis. The inside radius of the sphere under discussion is “R”.

Electrical conductive material, referred to as “Coils” and similar to everyday copper wires, is run between the North and South poles along the outside circumference of the sphere. Ideally this conductive material should be actually be of semiconductor material. Such materials are better suitable to computer controlled and will be able to take advantage of solid state fabrication techniques. The coils will be equally dispersed radially around the circumference with a maximum separation of at least one coil per radial degree (1 coil/degree). This will insure a consistent and uniform distribution of magnetic field.

Electrical current, in Amperes as described below, will be conducted along each coil with the electrical circuit completed at only one place, either at the top or the bottom of the sphere, depending on construction methodologies. Each coil will be insulated from its neighboring coil.

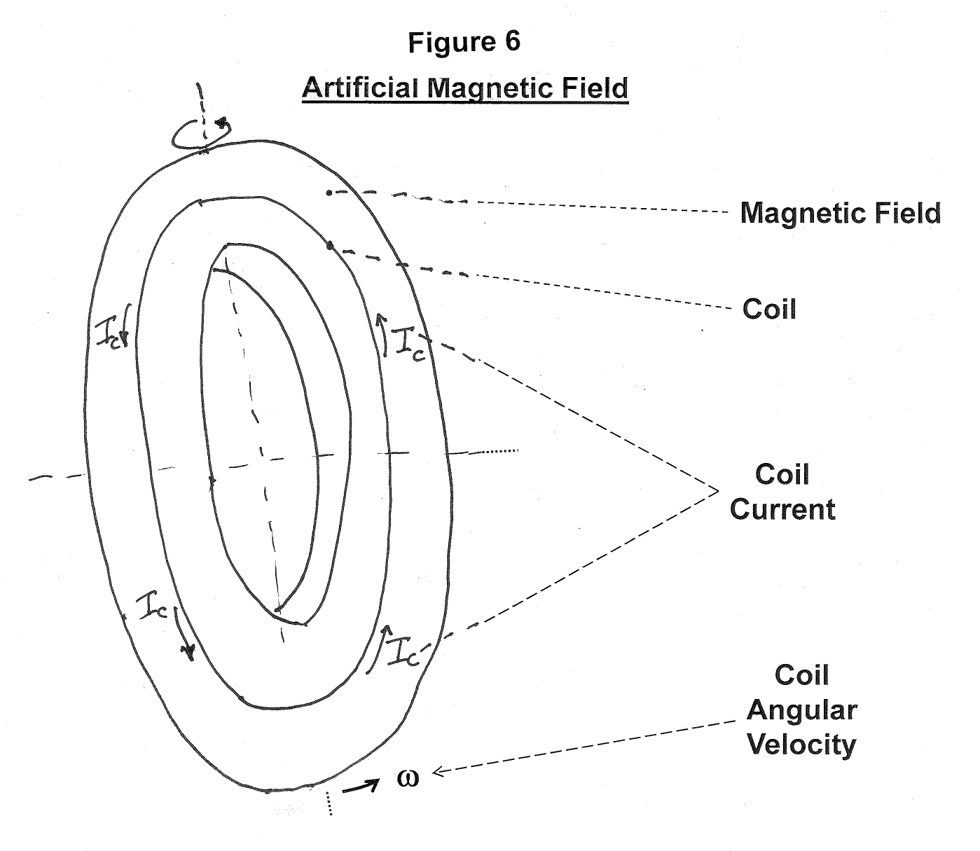

Unlike the Earth's magnetosphere, every effort will be made with this invention to minimize mechanical motion. Consequently, each coil will be made part of the electrical circuit based on a frequency of rotation. This frequency, which will be under computer control, is referred to as the “Coil Angular Velocity, ω”. The minimum such frequency will be 360 Hertz. This means that each coil will be energized a minimum of 1 time per second (1 Hertz). Each coil will be energized with the same current referred to as the “Coil Current, I_{c}”. Again the purpose is to insure a consistent and uniform distribution of magnetic field. A more detailed breakout of these coils is depicted in FIG. 6.

The net result is a uniform, rapidly rotating magnetic field referred to as the “Magnetic Density vector, B”. The unit of magnetic density will be the customary unit of Tesla, T. This uniform B field is also depicted in FIG. 6.

Based on a maximum magnetic field density of 20 nT, the coils will be energized with a sufficient value of current so as to generate a sufficiently strong B field. A well known principal of physics is that a current flowing in a conductor under steady-state (i.e., non-time varying conditions) creates a magnetic field. The applicable equation for these phenomena is the following:

B=(μₒI_{c})/(2πr)

where
B is the magnetic Field Density in Tesla
μₒ is the magnetic permeability of free space
I_{c} is the coil current in Amperes
R is the distance from the exterior of the sphere in meters, assuming that the coils are close to the surface of the sphere.

It turns out that a value of 0.01 mT at a distance of 0.1 meter (10 cm or roughly 4 inches) from the surface of the sphere provides a safety factor of 10,000 while utilizing a relatively low current. The low current values minimize the generation of waste heat, thermal stress on the coils and the need for heavy thermal insulation. It also minimizes the need for the use of exotic materials such as superconductors. The following values of current result:

TABLE 1

| Design B Field at | | Standoff Distance from |
|---|---|---|
| Design Distance, mT | I_{c}, Amps | Sphere, Meters |
| .01 | 2.5 | .05 |
| .01 | 5.0 | .1 |
| .01 | 25.0 | .5 |
| .01 | 50.0 | 1.0 |

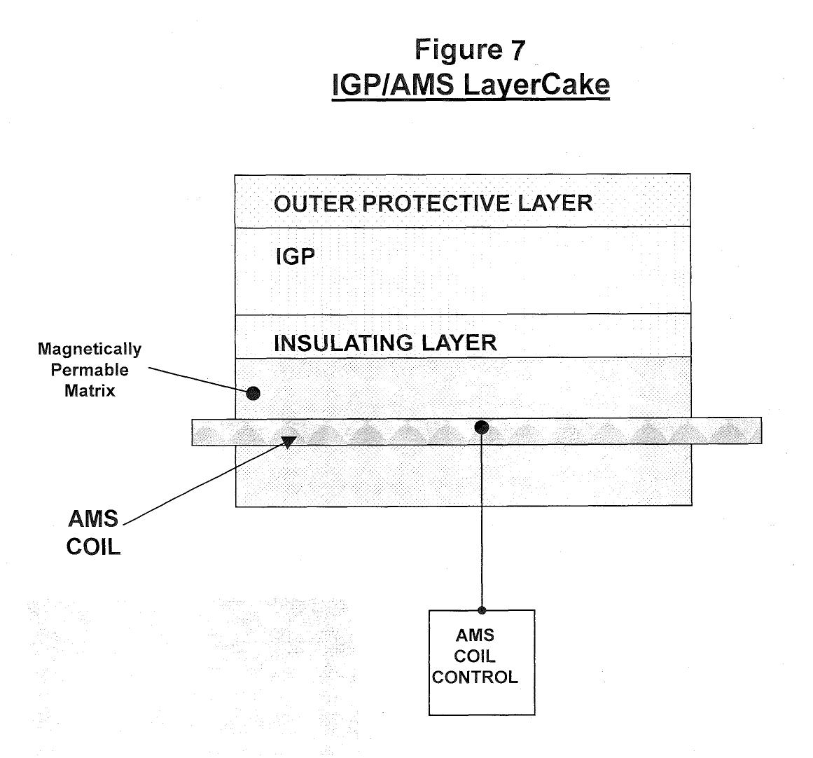

As it is the combination of IGP and artificial magnetic field (AMS) that enhances the artificial magnetosphere, the outer surface of the sphere must be comprised of a particular structure. This structure is depicted in FIG. 7. The outermost layer must be comprised of the standard protective material utilized on the International Space Station (ISS) of space shuttles. This material must be dsigned to defend against typical physical hazards such bas micrometeorites. The next layer (closer to the surface of the sphere) must be the IGP as described above and uniformly applied to the surface of the spacecraft (sphere). As the IGP may or may not be made of conductive materials, there must be an insulating material below it. This material must be the thinnest possible, to reduce weight, but must still maintain a satisfactory electrical impedance of 1 Megaohm, nominal and it must exhibit low magnetic permeability. As from the above Table 1, the I_{c} must be under dynamic, computer control so as to minimize power consumption while maximizing magnetic shield strength based on the environmental conditions encountered.

It should also be noted that in order to maximize magnetic shield strength based on the environmental conditions encountered, one of two trajectory parameters of the spacecraft (sphere) should be adjustable. These two parameters are the spacecraft (sphere) trajectory in three-dimensional space or the B vector angle with respect to the direction of travel in three-dimensions. Either of these should be easily manipulated with advanced control systems available currently. As expected, all electronics must be radiation hardened and must conform to required mil-standards.

What is claimed is:

1. A method of providing a spacecraft with an enhanced artificial magnetosphere or electromagnetic shield, which comprises providing the spacecraft with an Interference Generating Pattern (IGP) which is tuned to high-frequency radiation of X-rays and gamma rays, and embedding electrical current conductors in or near an outer surface of the spacecraft, thus creating an artificial Magnetosphere (AMS) to shield against dangers due to a variety of energetic particles prevalent in outer space.

2. The method of claim 1, wherein the IGP is configured to attenuate high frequency radiation in the range of 10¹³ to 10²⁰ MHZ and to reduce high frequency signals by at least 20 dB to 50 dB.

3. The method of claim 2, wherein the diffraction grating is provided as a paint or coating on one or more of the interior wall(s), ceiling or floor of the spacecraft.

4. The method of claim 1, wherein the IGP is comprised of different patterns constructed with different physical dimensions for each pattern.

5. The method of claim 4, wherein the IGP is comprised of horizontal or vertical layering of the different multiple patterns.

6. An electromagnetic radiation-free spacecraft provided by the method of claim 1.

7. An electromagnetic radiation-free spacecraft that includes a non-conductive interference generating pattern (IGP) which includes a diffraction grating that is tuned to high-frequency radiation of X-rays and gamma rays, and electrical current conductors in or near an outer surface of the spacecraft, thus creating an artificial Magnetosphere (AMS) to shield against dangers due to a variety of energetic particles prevalent in outer space.

8. The spacecraft of claim 7, wherein the IGP is configured to attenuate high frequency radiation in the range of 10¹³ to 10²⁰ MHZ and to reduce high frequency signals by at least 20 dB to 50 dB.

9. The spacecraft of claim 8, wherein the diffraction grating is provided as a paint or coating on one or more of the interior wall(s), ceiling or floor of the spacecraft.

10. The spacecraft of claim 7, wherein the IGP is comprised of different patterns constructed with different physical dimensions for each pattern.

11. The spacecraft of claim 10, wherein the IGP is comprised of horizontal or vertical layering of the different multiple patterns.
